(19) United States
(12) Patent Application Publication
(10) Pub. No.: US 2012/0091741 A1
(43) Pub. Date: Apr. 19, 2012

(54) DUAL PINCHER SECURITY SYSTEM TAG AND METHOD

(75) Inventor: Justin STEWART, Boca Raton, FL (US)

(73) Assignee: SENSORMATIC ELECTRONICS, LLC, Boca Raton, FL (US)

(21) Appl. No.: 12/907,150

(22) Filed: Oct. 19, 2010

(51) Int. Cl. G09F 3/03; B23P 11/00

(52) U.S. Cl. 292/307 A; 29/525.08

(57) ABSTRACT

A security tag that includes two different types of item-securing mechanisms within a single apparatus. The apparatus includes a first arm portion and a second arm portion forming a product clamping region, the product clamping region having a clamp to removably affix the tag to a product, and a third arm portion and a fourth arm portion forming a product piercing region, the product piecing region coupled to the product clamping region. The product piercing region includes a product piercing element to removably affix the tag to the product. Bringing together the arm portions of the product piercing region causes the arm portions of the clamping region to join together, thereby trapping a piece of a product therebetween. The piercing element of the product piercing region is retained by a latch which assists in keeping the arm portions of the clamping region together, thus retaining the product securely within the clamping region.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates generally to security tags for the prevention of unauthorized removal of an item from a controlled area and more specifically to a security tag that integrates both a pin-type securing feature and a pinless securing feature within the same tag.

### BACKGROUND OF THE INVENTION

A typical security system such as an Electronic Article Surveillance (“EAS”) system in a retail setting may include a monitoring system and one or more security tags or labels attached to articles to be protected from unauthorized removal. The monitoring system establishes a surveillance zone (also referred to as an interrogation zone), usually at an access point for the controlled area. Tags on articles which are authorized for removal from the area can be deactivated or removed so as not be detectable by the monitoring system. If the monitored item enters the surveillance zone with an active security tag, an alarm may be triggered to indicate possible unauthorized removal of the item.

As is known in the art, security tags (also referred to as labels) can be constructed in any number of configurations. The desired configuration of the tag or label is often dictated by the nature of the article to be protected. For example, pre-packaged goods which are subject to retail theft, such as CDs, DVDs, small electronic devices, etc., may contain a tag disposed within the packaging in such a way that it is hidden from the consumer at least during the pre-purchase period.

A tag may be enclosed in a rigid housing which can be secured to the monitored item, such as hard tags containing EAS, e.g., acousto-magnetic, and/or radio frequency identification (“RFID”) labels which are commonly attached to clothing and other articles in retail stores. The tag typically includes a pin which is inserted through the fabric or article and secured in place to a rigid housing. The tag housing cannot be removed from the clothing without destroying tag or clothing except by using a deactivation device such as, for example, a magnetic detaching unit to remove the pin from the housing.

However, some retailers may not want use pin-type tags exclusively. For example, certain high-end retailers and customers dislike having expensive merchandise, such as leather goods, potentially suffer some damage in order to prevent theft. Shoes are especially difficult to protect using a device having a pin as the material the shoe is constructed from may suffer permanent damage from the pin. For these types of items, a pinless tag may be desired. However, a store owner may find it inconvenient to stock up on two types of tags; pin-type tags and pinless tags. It would also require the retail store owner to train store staff to determine which items receive a pin-type tag and which items must receive a pin-less tag. Further, some pinless tags include clamps that require significant effort to squeeze together in order to trap an article between the clamps.

Therefore, what is needed is single security device that integrates both types of tag attachments, i.e., a pin-type attachment and a pinless attachment, within a single tag housing and that includes a mechanism to allow a user to attach the tag to an article within either attachment method and without undue effort.

### SUMMARY OF THE INVENTION

The present invention advantageously provides a security system tag and method in which the tag includes both a clamping region and piercing region for affixing the tag to an item.

In accordance with one aspect, the present invention provides a security tag having a product clamping region and a product piercing region. The product clamping region has a clamp to removably affix the security tag to a product. The product piercing region is coupled to the product clamping region. The product piercing region has a product piercing element to removably affix the tag to the product.

In accordance with another aspect, the present invention provides an apparatus in which a first arm portion and a second arm portion form a product clamping region. The product clamping region has a clamp to removably affix the tag to a product. A third arm portion and a fourth arm portion form a product piercing region in which the product piecing region is coupled to the product clamping region. The product piercing region has a product piercing element to removably affix the tag to the product.

In accordance with still another aspect, the present invention provides a method for facilitating attachment of a security tag to a product in which the security tag has a product clamping region with a clamp to removably affix the tag to the product, and a product piercing region. The product piecing region is coupled to the product clamping region such that the product piercing region and the clamping region are movable between an unlocked and a locked position. The product piercing region has a product piercing element and a receiving latch. At least a portion of the product is positioned in the clamping region. The portion of the product is clamped within the clamping region by moving the product piercing region to a locked position. The product piercing element is inserted within the receiving latch to secure the product within the clamping region.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of an exemplary security tag in an open position and constructed in accordance with the principles of the present invention;

FIG. 2 is a perspective view of the security tag of FIG. 1 in a closed configuration;

FIG. 3 is a perspective view of the security tag of FIG. 1 with an article secured to the clamping region; and

FIG. 4 is a perspective view of the security tag of FIG. 1 with an article secured to the piercing region.

### DETAILED DESCRIPTION OF THE INVENTION

Before describing in detail exemplary embodiments that are in accordance with the present invention, it is noted that the embodiments reside primarily in combinations of apparatus components and processing steps related to providing a security tag that integrates a pin-type clamping mechanism and a pin-less type clamping mechanism within the same housing. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

One embodiment of the present invention advantageously provides a security tag for securing items such as clothing. The security tag includes a first pin-type locking mechanism having a first arm and a second arm, and a pinless locking mechanism having a third arm and a fourth arm, where the pin-type locking mechanism and the pinless locking mechanism are pivotally joined by a hinge. Bringing together the first and second arms of the pin-type locking mechanism forces the third arm and fourth arm of the pinless locking mechanism to join together, thereby trapping a piece of an item between the third and the fourth arms. Of note, although the present invention is described in places herein with respect to clothing, the invention is not limited to such. The use of clothing as the protected article is made purely to aid understanding. Articles which can be pierced with a pin or grabbed with a clamp are suitable articles for protection using the present invention.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Numerous specific details may be set forth herein to provide a thorough understanding of the embodiments. It will be understood by those skilled in the art, however, that the embodiments may be practiced without these specific details. In other instances, well-known methods, procedures and components have not been described in detail so as not to obscure the embodiments. It can be appreciated that the specific structural and functional details disclosed herein may be representative and do not necessarily limit the scope of the embodiments.

The present disclosure will be understood more fully from the detailed description given below and from the accompanying drawings of particular embodiments of the invention which, however, should not be taken to limit the invention to a specific embodiment but are for explanatory purposes.

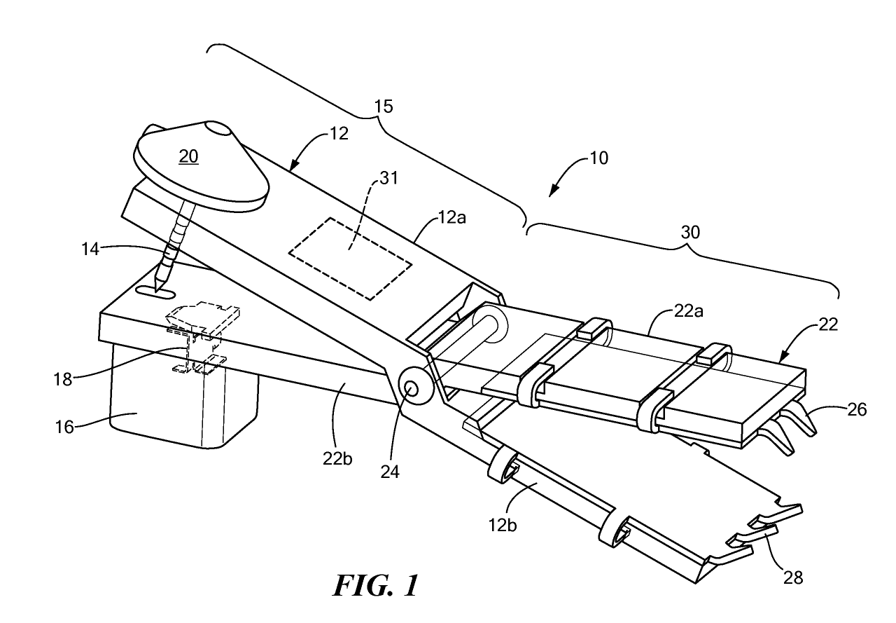

Referring now to the drawing figures in which like reference designators refer to like elements, there is shown in FIG. 1 an exemplary configuration of a security tag 10 according to an embodiment of the present invention. Tag 10 includes a first arm 12 that includes a first upper portion 12a and a second lower portion 12b. Tag 10 also includes a second arm 22 that includes a first upper portion 22a and a second lower portion 22b. Upper portion 12a of first arm 12 and lower portion 22b of second arm 22 collectively form a piercing region 15. Piercing region 15 includes a pin 14. Pin 14 extends downward from upper arm 12a and pierces an item to be protected, such as for example, a piece of clothing. Pin 14 is received within a receptacle 16 housed within lower arm 22b of second arm 22. Receptacle 16 lockingly receives the lower end of pin 14, thus trapping an item between upper portion 12a and lower portion 22b.

As shown in FIG. 1, pin 14 may include one or more circumferential grooves to facilitate the securing of pin 14 within receptacle 16. The grooves also serve the purpose of securing pin 14 within receptacle 16 at different levels, or heights, to compensate for different thicknesses in material of the product being secured. For example, for thinner clothing, a groove toward the upper end of pin 14 is locked within receptacle 16. For thicker material, a lower groove can be used. In this fashion, pin 14 can secure different types of articles of varying thickness.

Piercing region 15 includes portions 12a and 22b and is a pin-based locking mechanism that, as discussed above, pierces the item being secured. An item to be protected is placed between upper portion 12a of first arm 12 and lower portion 22b of second arm 22. As upper portion 12a is lowered, pin 14 is forced through the item, thus trapping the item between upper portion 12a and lower portion 22b. Pin 14 is secured within receptacle 16 thereby preventing the item from being removed from the tag without ripping or otherwise damaging the item. A latch 18 within receptacle 16 receives pin 14. To deactivate tag 10, a detaching unit can be used to release pin 14 from within latch 18. In one embodiment, latch 18 is a magnetic latch and a magnetic detaching unit is used to release pin 14 by applying a magnetic field to latch 18. The metallic material within latch 18 is attracted to the magnetic field thereby allowing pin 14 to be released from receptacle 16 and the item removed from within piercing region 15 without damage. The invention is not limited to a magnetic latch 18 or a magnetic detaching unit. Other pin lock and detaching arrangements, such as mechanical spring-based arrangements, may be employed.

Thus, apparatus 10 includes four arm portions forming two separate regions. Upper arm portion 22a (first arm portion) of second arm 22 and lower arm portion 12b (second arm portion) of first arm 12 form clamping region 30. Upper arm portion 12a (third arm portion) of first arm 12 and lower arm portion 22b (fourth arm portion) of second arm 22 form product piercing region 15. Piercing region 15 of apparatus 10 utilizes pin 14 to secure an item between upper portion 12a of first arm 12 and lower portion 22b of second arm 22. Pin 16 may include a lid 20, which houses the upper portion of pin 16 and can be separated from upper arm 12a of first arm 12. In an alternate embodiment, pin 16 is integrated within upper portion 12a. Hinge 24 allows upper portion 12a of first arm 12 and lower portion 22b of second arm 22, to pivot with respect to one another, i.e., allows upper portion 12a and lower portion 22b to open and close. In other words, piercing region 15 and clamping region 30 intersect at hinge 24.

Upper portion 22a of upper portion 22a and lower portion 12b, forming clamping region 30, also rotate about the axis of hinge 24 thus allowing upper portion 22a and lower portion 12b to open and close in order to secure an item or a portion of an item there between. A spring can be included within apparatus 10, to bias first arm 12 and second arm 22 in an open position. This facilitates use of apparatus 10 since a user can trap an article between the already-opened first set of arms, and apply pressure to the already-opened second set of arms, i.e., the arm portions forming piercing region 15, thus closing the first set of arms forming clamping region 30 and securing the article therein.

Clamping region 30 does not include pin 14 as is included in piercing region 15. Clamping region 30 is formed from portions 22a and 12b, which form a “clamp” to secure an item there between. Clamping region 30 utilizes protrusions or a pad to hold but not pierce a portion of the item to which apparatus 10 is attached. Because certain items, i.e., high priced clothing or shoes, may be damaged by the insertion of a pin, the “pinless” clamping region 30 has a pad or protrusions that can secure the item without the insertion of a pin which might cause damage to the item. For example, a first plurality of teeth 26 extend downward and outward from the end of upper portion 22a of second arm 22 and a second plurality of teeth 28 extend upward and outward from the end of lower portion 12b of first arm 12. Teeth 26 and 28 can be separate metal or non-metallic pieces affixed to upper portion 22a and lower portion 12b, respectively, or can be fabricated as an integrated part of portions 22a and 12b. Of note, although the present invention is described with respect to teeth 26 and 28, the invention is not limited to such. It is contemplated that other gripping and retention arrangements can be used such as ribs, ridges, spikes, pliant pads, etc.

When in the open position, upper portion 22a and lower portion 12b form clamping region 30 that receives the item or a portion of an item. Advantageously, hinge 24 allows a user to apply pressure to portions 12a and 22b in order to close portions 22a or 12b in order to secure an item therein. Similarly, hinge 24 allows a user to apply pressure to portions 22a and/or 12b in order to bring portions 12a and 22b together.

It is also contemplated that a benefit denial component, e.g., ink reservoir, can be included as part of apparatus 10. In such case, tampering with apparatus 10 to release it from the protected article without using a proper detacher activates the benefit denial feature and causes the article to be destroyed. For example, an ink reservoir can be affixed to pin 14 and located within lid 20 such that attempting to open/unlock apparatus 10 without using a proper detachment device will cause the pin 14 to break open the ink reservoir and release the ink, thereby destroying the protected article.

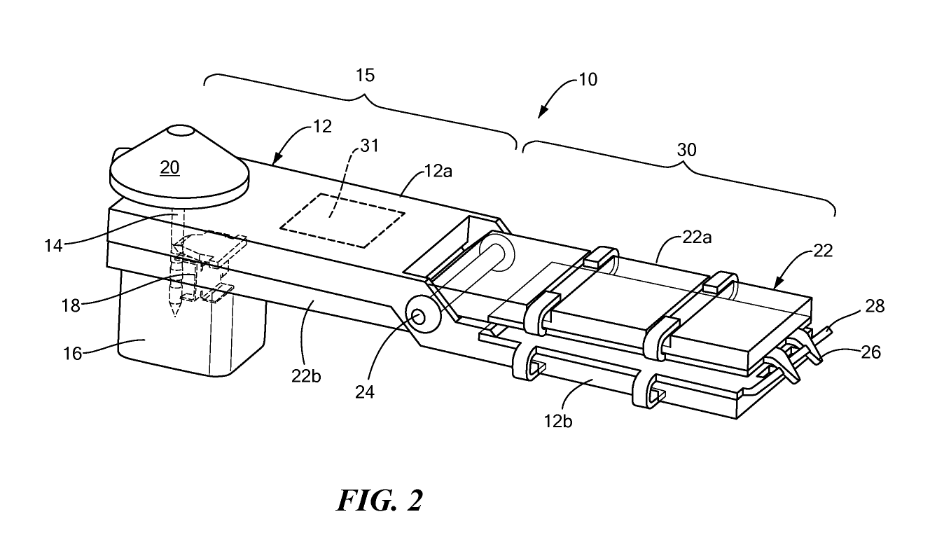

FIG. 2 is a diagram of an exemplary apparatus 10 in a closed orientation. Rather than manually squeezing together portions clamping region 30 in order to trap and secure an item therein, a user can grasp apparatus 10 by upper portion 12a of first arm 12 and lower arm 22b and apply pressure to one or both portions thus squeezing together portions 12a and 22b, which in turn forces upper portion 22a of second arm 22 and lower portion 12b of first arm 12 together, trapping the item therein. Teeth 26 and 28 assist in securing the item between upper portion 22a and lower portion 12b. By utilizing hinge 24, applying a small amount of pressure to portions 12a and 22b results in a large amount of clamping force applied to portions 22a and 12b.

When a user applies pressure to portions 12a and 22b, pin 14 is secured within latch 18, as described above. As a result, portions 22a and 12b remain clamped together around the protected item without the additional application of user pressure. Thus, once a user applies pressure to portions 12a and 22b, portions 22a and 12b remain joined together once pin 14 is inserted within receptacle 16 and received by latch 18. The user can then release portions 12a and 22b, which does not affect the closed orientation of portions 22a and 12b. As long as pin 14 remains secured within latch 18, portions 12a and 22b remain in a closed, i.e., clamped, orientation, with a secured item there between.

Apparatus 10 need not be of the linear shape depicted in FIGS. 1 and 2. Apparatus 10 can be of different shapes, such as, for example, an L-shaped configuration. By adjusting the location and tension of hinge 24, the user of apparatus 10 can gain a mechanical advantage that allows him or her to apply small amounts of pressure to portions 12a and 22b resulting in the application of much larger amounts of pressure upon portions 22a and 12b. Thus, rather than the user having to grasp portions 22a and 12b and force them together manually in order to pinch or otherwise grasp an item, apparatus 10 allows the user to merely grasp portions 12a and 22b and apply a small amount of pressure which in turn brings portions 22a and 12b close together via hinge 24, trapping an item therein.

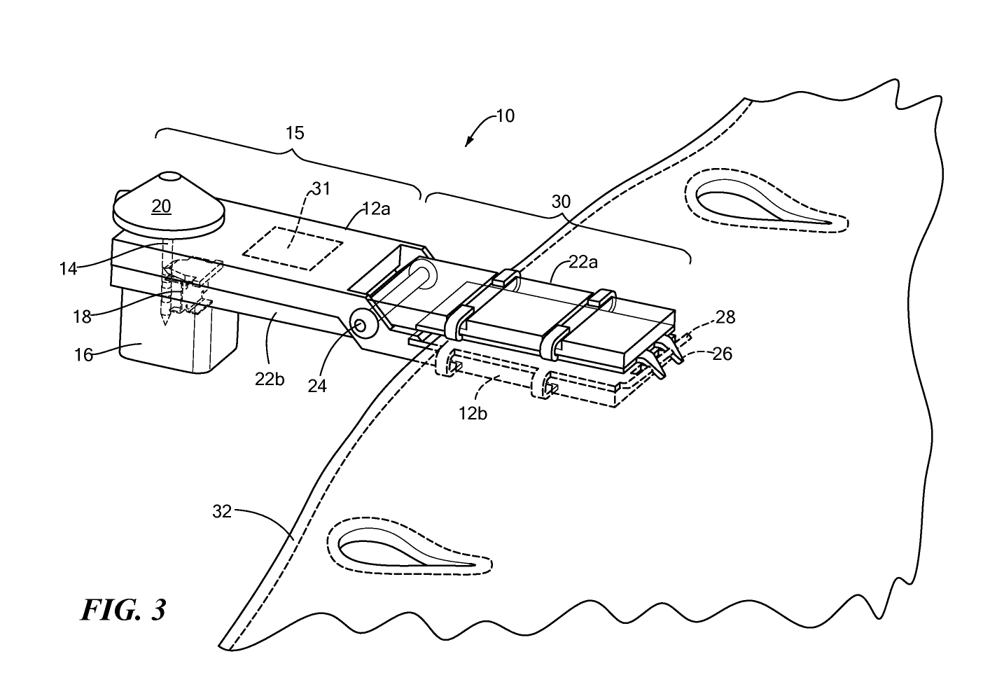

FIG. 3 is a diagram of an exemplary apparatus 10 in a closed configuration, where an item 32 such as a coat is retained between portions 22a and 12b. In this configuration, item 32 is retained within portions 22a and 12b and between teeth 26 and 28. To obtain the configuration shown in FIG. 3, a user can grasp and apply pressure to one or both of portions 12a or 22b order to bring the portions together. As portions 12a and 22b are brought together, hinge 24 also brings portions 22a and 12b together, thus eliminating the need to manually press portions 22a and 12b together in order to grasp item 32. As portions 12a and 22b are brought closer together, pin 14 is received and locked by latch 18 within receptacle 16. The user can use lid 20 to apply added pressure upon pin 14. Latch 18 receives and secures pin 14, thus “clamping” together portions 12a and 22b. The mating of pin 14 within latch 18 prevents the inadvertent separation, i.e., opening, of portions 12a and 22b. The mating arrangement of pin 14 within latch 18 also serves to force portions 22a and 12b of clamping region 30 together, resulting in a secure grip upon item 32. Similarly, if an item requires a pin-type security tag, portions 22a and 12b of clamping region 30 can be brought together in order to bring portions 12a and 22b of piercing region 15 together. This allows pin 14 to pierce an article and retain it once pin 14 is received within latch 18.

The invention described herein provides two different security tag attachment arrangements within a single apparatus 10. In one embodiment, piercing region 15 is a pin-type engagement mechanism that pierces and traps an item between portions 12a and 22b. Pin 14 pierces a portion of the item as pin 14 extends through the item and into latch 18. The item cannot be removed from first attachment mechanism 12 without severely damaging the item. Clamping region 30 is a pinless-type securing engagement mechanism, which traps item 32 between portions 22a and 12b but without piercing the item 32. Closing together portions 12a and 22b of piercing region 15 will also bring portions 22a and 12b toward each other. Similarly, bringing together portions 22a and 12b will bring together portions 12a and 22b. Thus one of regions 15 and 30 can be used as a lever to facilitate the closing of the other region.

Apparatus 10 can include a product identification element 31 such as a radio frequency identification (“RFID”) device and/or an electronic article surveillance (“EAS”) device (referred to collectively as 31). By affixing an EAS tag to apparatus 10, removal of item 32 to which apparatus 10 is attached without deactivation of apparatus 10 will sound an alarm. Further, inclusion of an RFID sensor within apparatus 10 can provide information to a store owner about the identity of item 32 attached to apparatus 10. The element 31 can be detected when apparatus 10 is brought within an interrogation zone or can transmit signals to a corresponding reader. Other alarming devices can be included within apparatus 10 including a sensor that will activate if item 32 is removed from apparatus 10. Element 31 can be located anywhere on or in apparatus 10 include upper portion 12a or lower portion 22b of piercing region 15 as well as upper portion 22a or lower portion 12b of clamping region 30.

A user can use apparatus 10 in multiple and different scenarios. For example, one apparatus 10 can be used to secure items via either piercing region 15 or pin-less clamping region 30. This eliminates the need to stock separate pin-type tags as well as pinless tags. By stocking their store inventory with apparatus 10, store owners need only determine which items 32 will be protected using the piercing region 15 and which items 32 will be protected using the pin-less, clamping region 30. Further, apparatus 10 delivers a mechanical advantage to the user by facilitating the capture of items 32. By squeezing together portions 12a and 22b of piercing region 15, the portions 22a and 12b of clamping region 30 are also brought together to secure item 32. Thus, the need to manually force portions 22a and 12b together is eliminated. To further secure item 32 within clamping region 30 and to prevent portions 22a and 12b from separating, pin 14 is “locked” within clamp 18 when portion 12a and portion 22b are closed together. Similarly, pressing together portions 22a and 12b of clamping region 30 brings portions 12a and 22b of piercing region together.

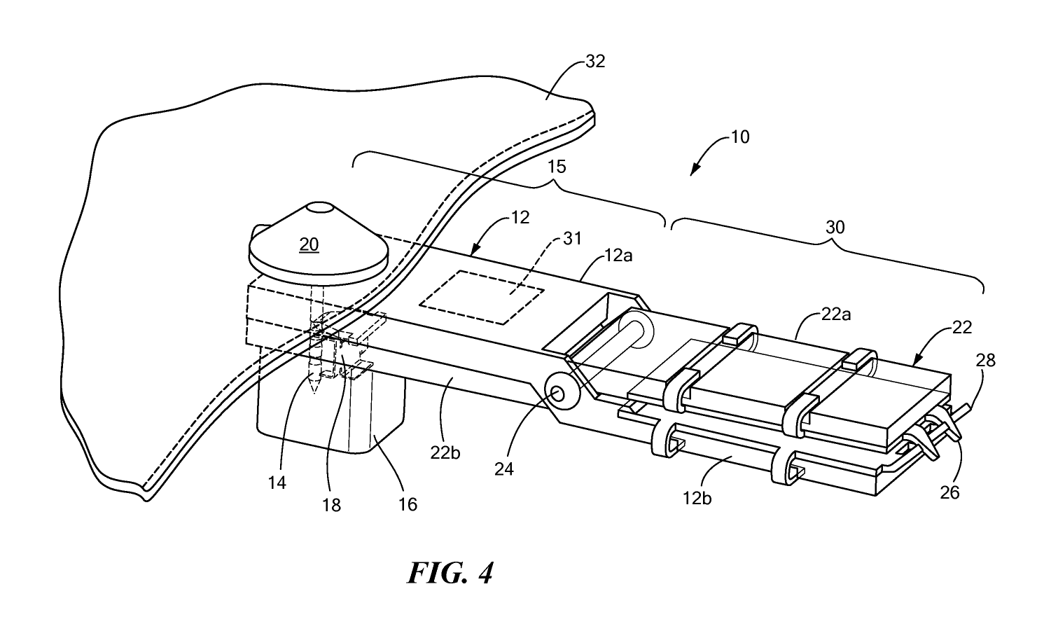

Referring to FIG. 4, article 32 is clamped between portions 12a and 22b of piercing region 15. Pin 14 pierces article 32 and is received by latch 18 in receptacle 16. Because portions 22a and 12b are closed, portions 12a and 22b are also closed. Advantageously, apparatus 10 can secure an article 32 within either piercing region 15 or clamping region 30, by actuating the other side. Thus, in the embodiment in FIG. 4, actuation of clamping region 30, i.e., bringing portions 22a and 12b toward each other, in turn actuates piercing region 15, i.e., brings portions 12a and 22b toward each other. This forces pin 14 through article 32, piercing the article 32. Pin 14 can be inserted within latch 18 of receptacle 16 thus preventing the removal of article 32.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A security tag, comprising:
a product clamping region, the product clamping region having a clamp to removably affix the security tag to a product; and
a product piercing region, the product piercing region coupled to the product clamping region, the product piercing region having a product piercing element to removably affix the tag to the product.

2. The security tag of claim 1, wherein the product piercing region and the product clamping region are formed by a first arm and a second arm hingedly coupled to the first arm.

3. The security tag of claim 1, wherein the product piercing region and the clamping region are movable between a locked position and an unlocked position.

4. The security tag of claim 3, wherein moving one or the other of the clamping region and the product piercing region to a locked position moves the other of the clamping region and the product piercing region to a locked position.

5. The security tag of claim 3, wherein the product piercing region includes a latch, the latch securing the piercing element when the product piercing region is in the locked position.

6. The security tag of claim 5, wherein securing the piercing element in the latch retains the clamping region in the locked position.

7. The security tag of claim 1, wherein the piercing element is a pin.

8. The security tag of claim 7, wherein the pin includes a plurality of circumferential grooves, the plurality of circumferential grooves operate to lock the clamping region in a plurality of positions.

9. The security tag of claim 1, wherein the clamping region includes a plurality of teeth to facilitate grasping of the product.

10. The security tag of claim 1, wherein at least one of the product piercing region and the clamping region includes at least one of a radio frequency identification (“RFID”) device and an electronic article surveillance (“EAS”) tag.

11. An apparatus, comprising:
a first arm portion and a second arm portion forming a product clamping region, the product clamping region having a clamp to removably affix the tag to a product; and
a third arm portion and a fourth arm portion forming a product piercing region, the product piecing region coupled to the product clamping region, the product piercing region having a product piercing element to removably affix the tag to the product.

12. The apparatus of claim 11, wherein the product piercing region and the clamping region are movable between a locked position and an unlocked position.

13. The apparatus of claim 12, wherein moving one or the other of the clamping region and the product piercing region to a locked position moves the other of the clamping region and the product piercing region to a locked position.

14. The apparatus of claim 12, wherein the product piercing region includes a latch for securing the piercing element when the product piercing region is in the locked position.

15. The apparatus of claim 14, wherein securing the piercing element in the latch retains the clamping region in the locked position.

16. The apparatus of claim 11, wherein the piercing element is a pin and wherein the pin includes at least one circumferential groove.

17. The apparatus of claim 16, further including a benefit denial component, the benefit denial component arranged to destroy the product if an unauthorized attempt is made to remove the apparatus from the product.

18. The apparatus of claim 11, wherein the clamping region includes a plurality of teeth to facilitate grasping of the product.

19. The apparatus of claim 11, wherein at least one of the product piercing region and the clamping region includes at least one of a radio frequency identification (“RFID”) device and an electrical article surveillance (“EAS”) tag.

20. A method for facilitating attachment of a security tag to a product, the security tag comprising a product clamping region, the product clamping region having a clamp to removably affix the tag to the product, and a product piercing region, the product piecing region coupled to the product clamping region, the product piercing region and the clamping region movable between an unlocked and a locked position, the product piercing region having a product piercing element and a receiving latch, the method comprising:
positioning at least a portion of the product in the clamping region;
clamping the portion of the product within the clamping region by moving the product piercing region to a locked position; and
inserting the product piercing element within the receiving latch to secure the product within the clamping region.
